(19) United States
(12) Patent Application Publication
(10) Pub. No.: US 2009/0077444 A1
(43) Pub. Date: Mar. 19, 2009

(54) METHOD AND APPARATUS FOR PROVIDING ACKNOWLEDGEMENT SIGNALING TO SUPPORT AN ERROR CONTROL MECHANISM

(75) Inventors: Xin Qi, Beijing (CN); Xiaoyi Wang, Beijing (CN)

Correspondence Address: DITTHAVONG MORI & STEINER, P.C., 918 Prince St., Alexandria, VA, 22314, US

(73) Assignee: Nokia Corporation, Espoo (FI)

(21) Appl. No.: 12/209,431

(22) Filed: Sep. 12, 2008

Related U.S. Application Data
(60) Provisional application No. 60/973,028, filed on Sep. 17, 2007.

(51) Int. Cl. H04L 1/18; G06F 11/00

(52) U.S. Cl. 714/748; 714/776; 714/E11.001

(57) ABSTRACT

An approach is provided for acknowledgement signaling. A determination is made whether an error control mechanism is enabled for transmission of a data frame. The data frame is fragmented into a plurality of coding blocks. A frame check sequence is appended to one or more sequences of the coding blocks, wherein each of the sequences associated with the frame check sequence is to be acknowledged separately.

### RELATED APPLICATIONS

This application claims the benefit of the earlier filing date under 35 U.S.C. 119(e) of U.S. Provisional Application Ser. No. 60/973,028 filed Sep. 17, 2007, entitled “Method and Apparatus for Providing Acknowledgement Signaling to Support an Error Control Mechanism,” the entirety of which is incorporated herein by reference.

### BACKGROUND

Radio communication systems, such as a wireless data networks (e.g., Third Generation Partnership Project (3GPP) Long Term Evolution (LTE) systems, spread spectrum systems (such as Code Division Multiple Access (CDMA) networks), Time Division Multiple Access (TDMA) networks, WiMAX (Worldwide Interoperability for Microwave Access), etc.), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One area of effort involves error control to ensure successful delivery of information. The use of Acknowledgements (ACKs) and/or Negative Acknowledgements (NACKs) are required to indicate whether data has been received successfully, or unsuccessfully. This mechanism is executed by a transmitter and a receiver to notify the transmitter whether the data has to be retransmitted. Such mechanism can introduce unnecessary overhead, degrade system performance, and result in waste of network resources, if not designed properly. Further, acknowledgement signaling is particularly critical in the context of error control.

### SOME EXEMPLARY EMBODIMENTS

Therefore, there is a need for an approach for providing an efficient acknowledgement scheme, which can co-exist with already developed standards and protocols.

According to one embodiment of the invention, a method comprises determining that an error control mechanism is enabled for transmission of a data frame. The method also comprises fragmenting the data frame into a plurality of coding blocks. Further, the method comprises appending a frame check sequence to one or more sequences of the coding blocks, wherein each of the sequences associated with the frame check sequence is to be acknowledged separately.

According to another embodiment of the invention, an apparatus comprises logic configured to determine that an error control mechanism is enabled for transmission of a data frame. The apparatus also comprises a fragmentation module configured to fragment the data frame into a plurality of coding blocks. The logic is further configured to append a frame check sequence to one or more sequences of the coding blocks. Each of the sequences associated with the frame check sequence is acknowledged separately.

According to another embodiment of the invention, a method comprises receiving a plurality of coding blocks representing a fragmented data frame. The method also comprises computing a frame check sequence associated with one or more sequences of the coding blocks. Further, the method comprises generating an acknowledgement signal, according to an error detection scheme, for each of the sequences associated with the frame check sequence.

According to yet another embodiment of the invention, an apparatus comprises a transceiver configured to receive data over a wireless network. The apparatus also comprises a processor configured to receive a plurality of coding blocks representing a fragmented data frame, and to compute a frame check sequence associated with one or more sequences of the coding blocks. The processor is further configured to generate an acknowledgement signal, according to an error detection scheme, for each of the sequences associated with the frame check sequence.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of providing an acknowledgement (ACK) channel to support multiple error control-enabled connections, according to various exemplary embodiments of the invention;

FIG. 2 is a diagram of a radio communication system capable of providing a hybrid Automatic Repeat Request (ARQ) (HARQ) scheme with coding-block based error detection, according to various embodiments of the invention;

FIG. 3 is a flowchart of a process for providing error control and data retransmission, according to various exemplary embodiments;

FIG. 4 is a diagram of data frames used in an exemplary error control and data retransmission scheme, according to one embodiment;

FIG. 5 is an exemplary HARQ encoder packet utilized in the system of FIG. 1;

FIG. 6 is a flowchart of a process for acknowledgement signaling in support of an error control mechanism, according to various exemplary embodiments;

FIG. 7 is a flowchart of a process for providing data retransmission, according to various exemplary embodiments;

FIGS. 8A and 8B are diagrams of an exemplary WiMAX (Worldwide Interoperability for Microwave Access) architecture, in which the system of FIG. 1 can operate, according to various exemplary embodiments of the invention;

FIGS. 9A-9D are diagrams of communication systems having exemplary long-term evolution (LTE) architectures, in which the user equipment (UE) and the base station of FIG. 1 can operate, according to various exemplary embodiments of the invention;

FIG. 10 is a diagram of hardware that can be used to implement an embodiment of the invention; and

FIG. 11 is a diagram of exemplary components of a user terminal configured to operate in the systems of FIGS. 8 and 9, according to an embodiment of the invention.

### DETAILED DESCRIPTION

An apparatus, method, and software for providing acknowledgement signaling to support an error control mechanism are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a wireless network compliant with a WiMAX (Worldwide Interoperability for Microwave Access) communication network (e.g., compliant with Institute of Electrical & Electronics Engineers (IEEE) 802.16), a 3GPP LTE or EUTRAN (Enhanced UMTS (Universal Mobile Telecommunications System) Terrestrial Radio Access Network)) architecture, it is recognized by one of ordinary skill in the art that the embodiments of the inventions have applicability to any type of packet based communication system and equivalent functional capabilities.

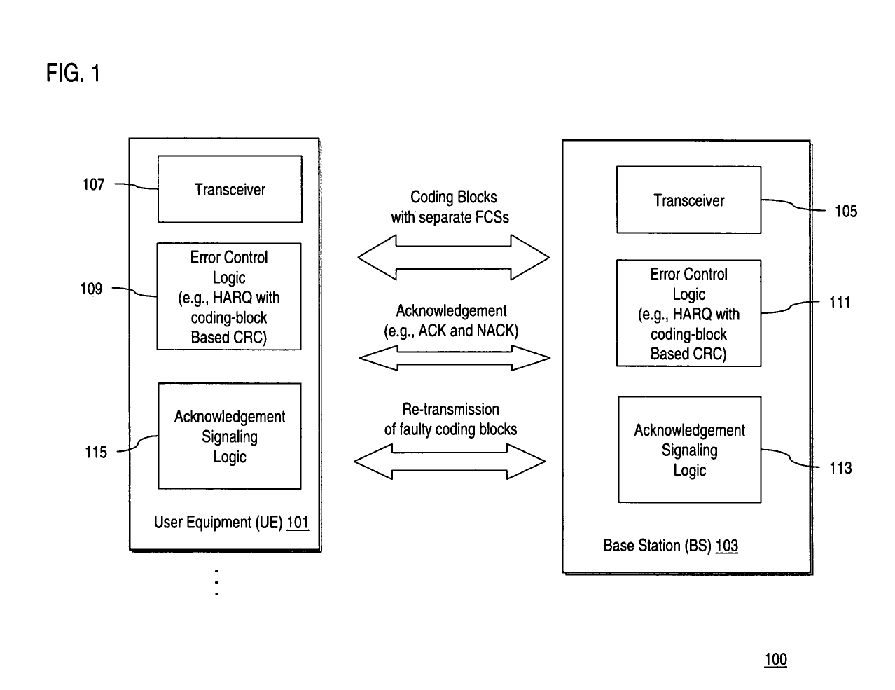

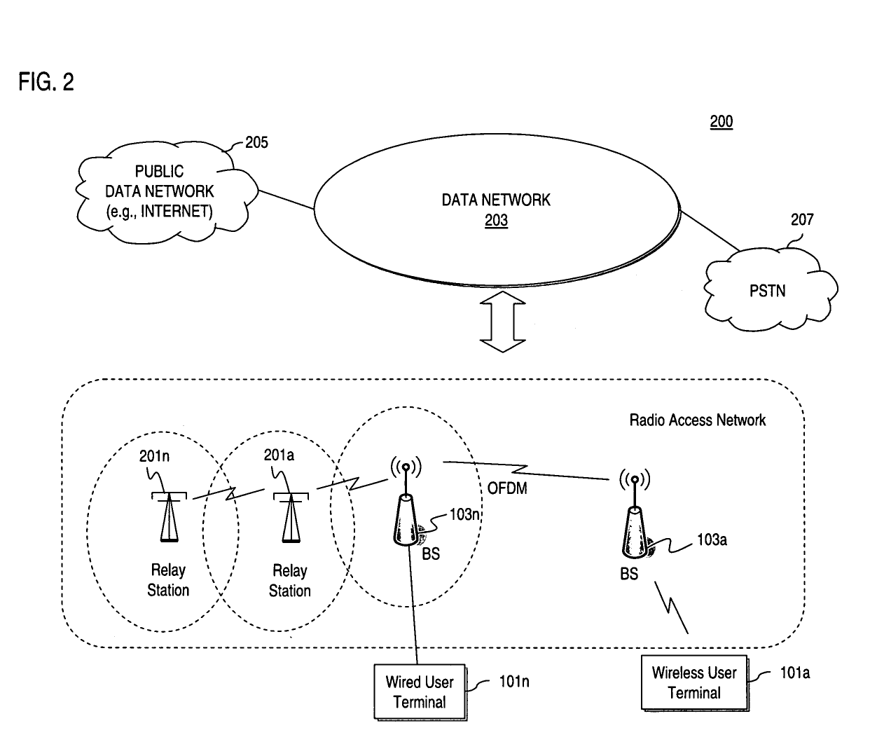

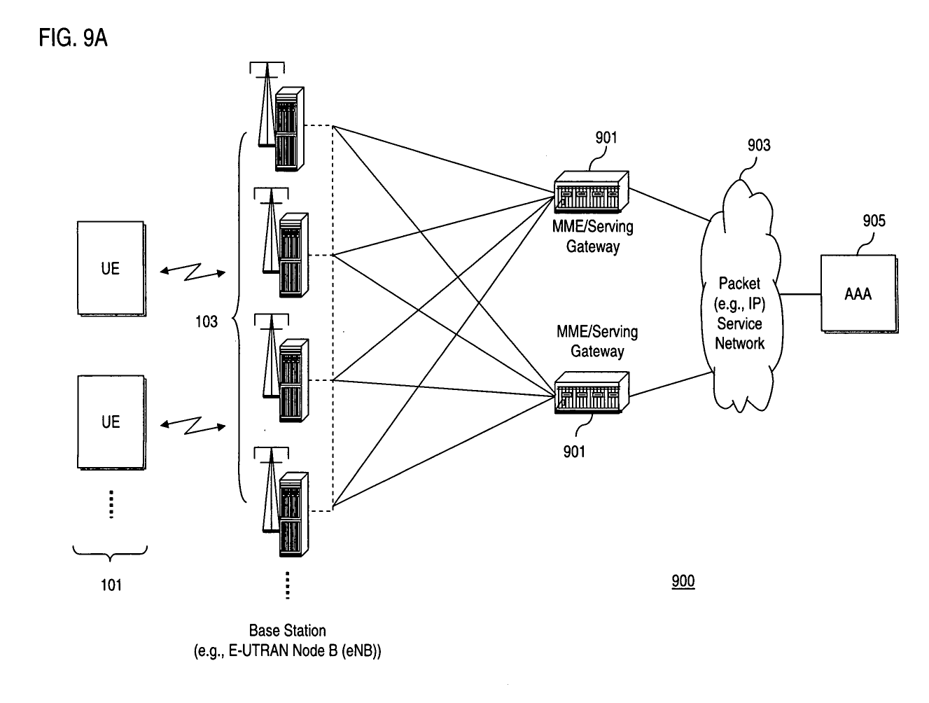

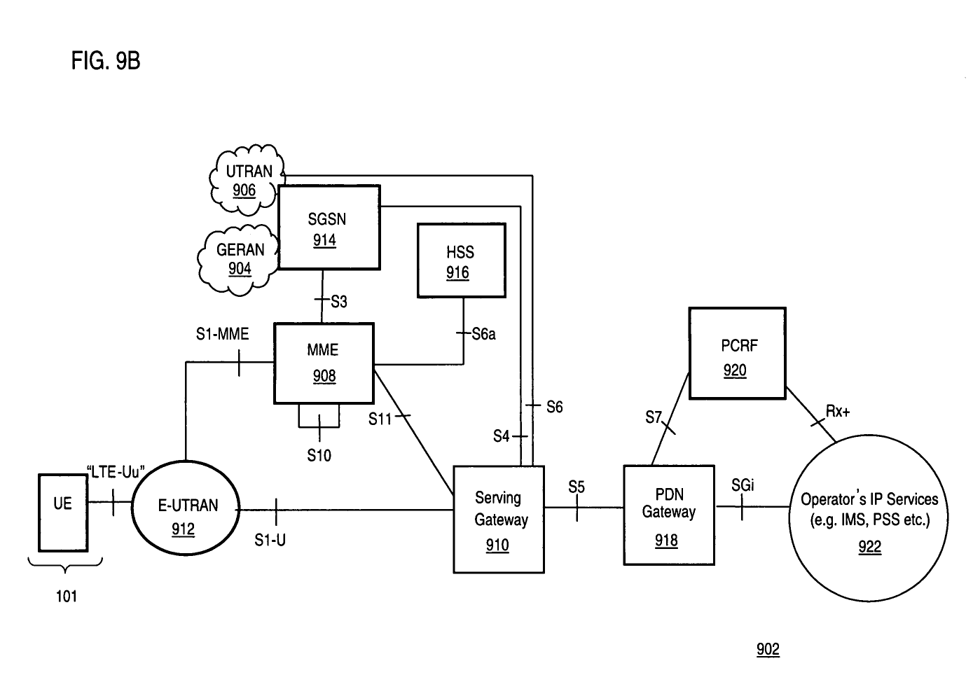

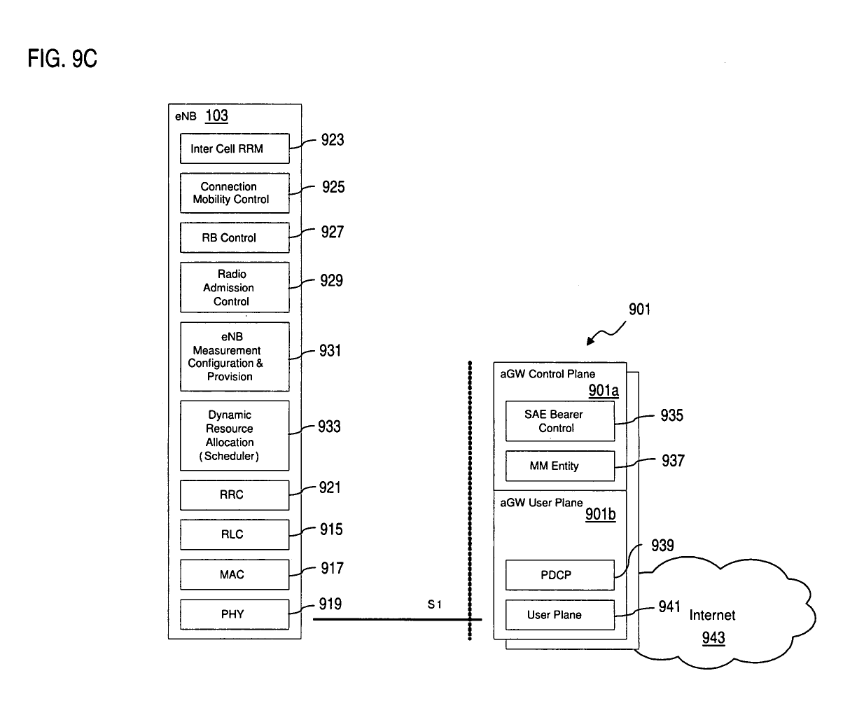

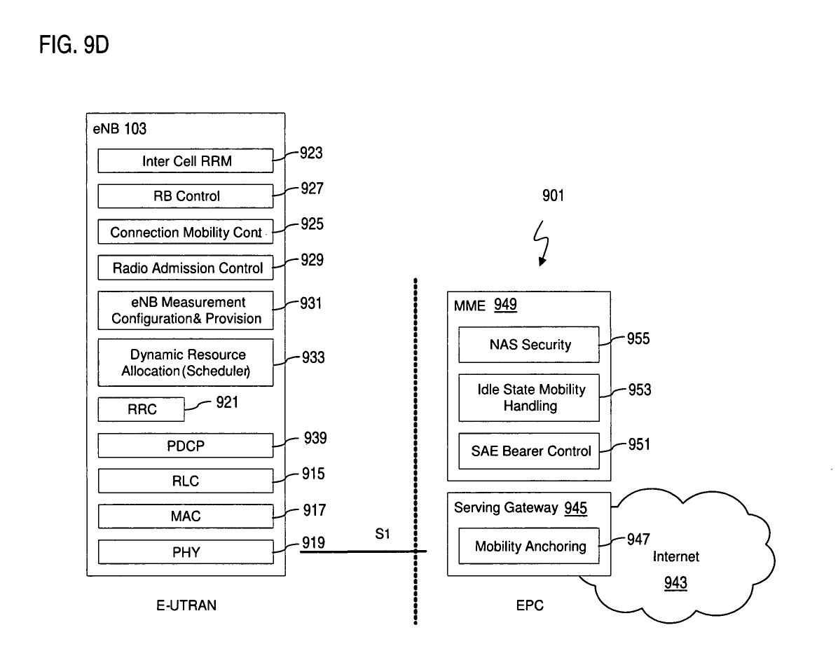

FIG. 1 is a diagram of a communication system capable of providing an acknowledgement (ACK) channel to support multiple error control-enabled connections, according to various exemplary embodiments of the invention. As shown in FIG. 1, one or more user equipment (UEs) 101 communicate with a base station 103, which is part of an access network (e.g., 3GPP LTE (or E-UTRAN), WiMAX, etc.). For example, under the 3GPP LTE architecture (as shown in FIGS. 9A-9D), the base station 103 is denoted as an enhanced Node B (eNB). The UE 101 can be any type of mobile stations, such as handsets, terminals, stations, units, devices, multimedia tablets, Internet nodes, communicators, Personal Digital Assistants or any type of interface to the user (such as “wearable” circuitry, etc.). The UE 101 can communicate with the base station 103 wirelessly, or through a wired connection. The communication system 100 can extend network coverage through the use of one or more relay nodes (shown in FIG. 2).

In the wireless case, the base station 103 employs a transceiver 105, which transmits information to the UE 101 via one or more antennas (not shown) for transmitting and receiving electromagnetic signals. The UE 101, likewise, employs a transceiver 107 to receive such signals. For instance, the base station 103 may utilize a Multiple Input Multiple Output (MIMO) antenna system for supporting the parallel transmission of independent data streams to achieve high data rates between the UE 101 and base station 103. The base station 103, in an exemplary embodiment, uses OFDM (Orthogonal Frequency Divisional Multiplexing) as a downlink (DL) transmission scheme and a single-carrier transmission (e.g., SC-FDMA (Single Carrier-Frequency Division Multiple Access) with cyclic prefix for the uplink (UL) transmission scheme. SC-FDMA can also be realized using a DFT-S-OFDM principle, which is detailed in 3GGP TR 25.814, entitled “Physical Layer Aspects for Evolved UTRA,” v.1.5.0, May 2006 (which is incorporated herein by reference in its entirety). SC-FDMA, also referred to as Multi-User-SC-FDMA, allows multiple users to transmit simultaneously on different sub-bands.

The UE 101 and base station 103 include error control logic 109, 111, respectively, for executing a hybrid Automatic Repeat Request (ARQ) (HARQ) scheme, as well as an acknowledgement signaling logic 113, 115. Automatic Repeat Request (ARQ) is an error detection mechanism used on the link layer. This mechanism permits a receiver to indicate to the transmitter that a packet or sub-packet has been received incorrectly, and thus, requests the transmitter to resend the particular packet(s). In the system 100, either of the UE 101 or BS 103 can behave as a receiver or transmitter at any particular time.

By way of example, the UE 101 and the base station 103 can communicate according to an air interface defined by IEEE 802.16. Details of various IEEE 802.16 protocols are more fully described in the following references, along with additional background materials (which are incorporated herein by reference in their entireties): [1] IEEE 802.16Rev2/D6a, “IEEE draft standard for Local and Metropolitan Area Networks—Part 16: Air Interface for Fixed Broadband Wireless Access systems”, July 2008; [2] Draft IEEE 802.16m Requirements, [online] http://www.ieee802.org/16/tgm/docs/80216m-07_{—}002r4.pdf; and [3] Shashikant Maheshwari, Adrian Boariu, “MS Aggregation of UL HARQ Reports in 802.16m network”, NSN invention report

IEEE 802.16 supports a number of channel coding schemes, including convolutional code (CC), convolutional turbo code (CTC), block turbo code (BTC) and low-density parity check (LDPC) code. These coding schemes support chase combining HARQ; CC and CTC support incremental redundancy (IR) HARQ. In HARQ enabled channel encoding process, the information bits (allocated to one physical layer (PHY) burst) are firstly appended with a 16 bit CRC in the tail. Thereafter, information bits of the burst are fragmented into coding blocks according to certain rules, if the length of information bits exceeds the maximum possible length for encoding. Each coding block is encoded independently.

At the receiver side (e.g., UE 101), firstly the coding block are decoded, then information bits of all coding blocks are concatenated. If the cyclic redundancy check (CRC) shows that the burst is not decoded successfully, a negative acknowledgement (NAK) will be sent to the transmitter (e.g., BS 103) to request the retransmission of the burst.

When the PHY burst is fragmented into multiple coding blocks, the key problem with the conventional 802.16 HARQ procedure is that even if only one of the coding blocks is not decoded successfully, the whole PHY burst has to be retransmitted. Thus, PHY bandwidth is wasted since all the successfully decoded blocks are also retransmitted.

More specifically, in 802.16, medium access control (MAC) protocol data units (PDUs) are first concatenated and then mapped into a PHY burst. A PHY burst is the basic unit for HARQ processing. If HARQ is enabled, one cyclic redundancy check (CRC) is added to the end of the information bits of the PHY burst. After this, the information bits of a PHY burst may be fragmented into multiple coding blocks and encoded, if the length of the information bits exceeds the maximum possible coding block length.

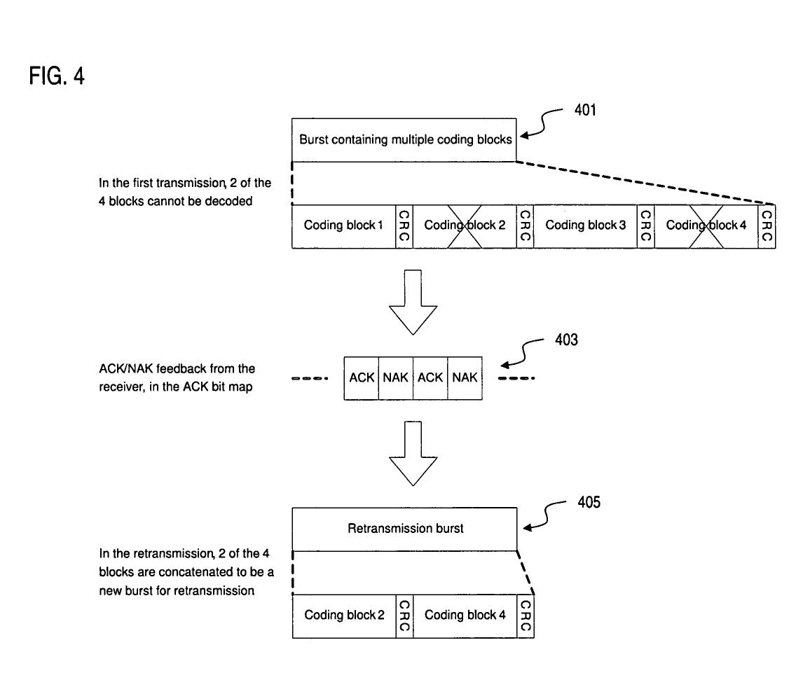

To address the above drawback, according to one embodiment, the system of FIG. 1 provides that after PHY-layer data is fragmented into multiple coding blocks, a CRC is appended to each of the coding blocks when HARQ is enabled, instead of that one CRC is appended to the whole PHY burst before fragmentation. In this manner, the decoding error of a single coding block results only in the retransmission of the single coding block, not the whole PHY burst. Therefore, the system throughput is improved. This process is more fully described below with respect to FIGS. 4-7.

FIG. 2 is a diagram of a radio communication system capable of providing a hybrid Automatic Repeat Request (ARQ) (HARQ) scheme with coding-block based error detection, according to various embodiments of the invention. For the purposes of illustration, the communication system 200 of FIG. 2 is described with respect to a wireless mesh network (WMN) using WiMAX (Worldwide Interoperability for Microwave Access) technology for fixed and mobile broadband access. WiMAX, similar to that of cellular technology, employs service areas that are divided into cells. As shown, multiple base stations 103a-103n or base transceiver stations (BTSs)—constitute the radio access network (RAN). WiMAX can operate using Line Of Sight (LOS) as well as near/non LOS (NLOS). The radio access network, which comprises the base stations 103 and relay stations 201a-201n, communicates with a data network 203 (e.g., packet switched network), which has connectivity to a public data network 205 (e.g., the global Internet) and a circuit-switched telephony network 207, such as the Public Switched Telephone Network (PSTN).

In an exemplary embodiment, the communication system of FIG. 2 is compliant with IEEE 802.16. The IEEE 802.16 standard provides for fixed wireless broadband Metropolitan Area Networks (MANs), and defines six channel models, from LOS to NLOS, for fixed-wireless systems operating in license-exempt frequencies from 2 GHz to 11 GHz. In an exemplary embodiment, each of the base stations 103 uses a medium access control layer (MAC) to allocate uplink and downlink bandwidth. As shown, Orthogonal Frequency Division Multiplexing (OFDM) is utilized to communicate from one base station to another base station. For example, IEEE 802.16x defines a MAC (media access control) layer that supports multiple physical layer (PHY) specifications. For instance, IEEE 802.16a specifies three PHY options: an OFDM with 256 sub-carriers; OFDMA, with 2048 sub-carriers; and a single carrier option for addressing multipath problems. Additionally, IEEE 802.16a provides for adaptive modulation. For example, IEEE 802.16j specifies a multihop relay network, which can employ one or more relay stations to extend radio coverage.

The service areas of the RAN can extend, for instance, from 31 to 50 miles (e.g., using 2-11 GHz). The RAN can utilize point-to-multipoint or mesh topologies. Under the mobile standard, users can communicate via handsets within about a 50 mile range. Furthermore, the radio access network can support IEEE 802.11 hotspots.

The communication system of FIG. 2 can, according to one embodiment, provide both frequency and time division duplexing (FDD and TDD). It is contemplated that either duplexing scheme can be utilized. With FDD, two channel pairs (one for transmission and one for reception) are used, while TDD employs a single channel for both transmission and reception.

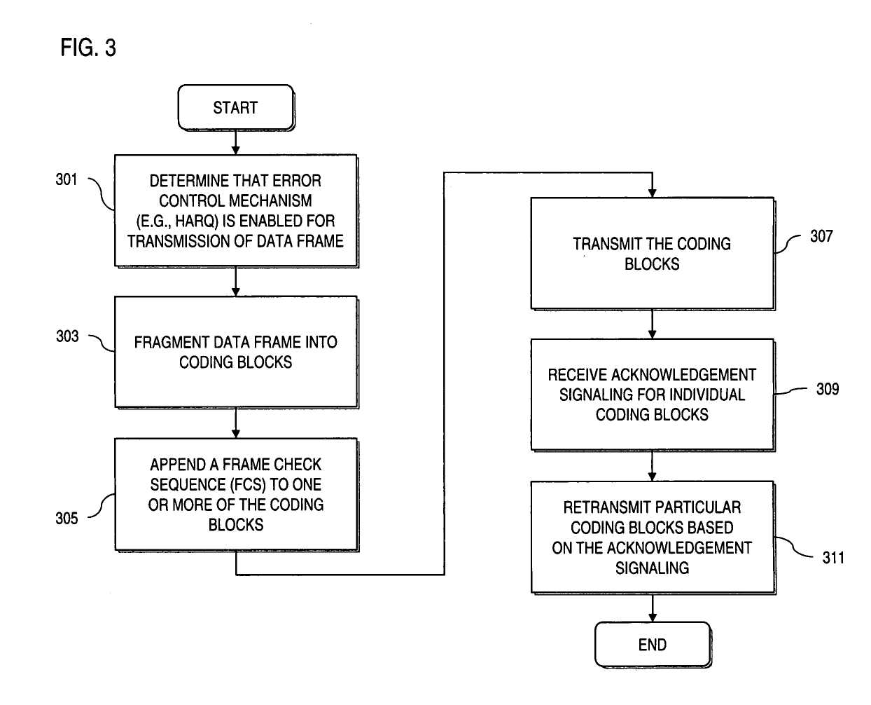

FIG. 3 is a flowchart of a process for providing error control and data retransmission, according to various exemplary embodiments. The process determines that an error control mechanism (e.g., HARQ) is enabled, per step 301. Accordingly, in step 303, a data frame is fragmented into coding blocks. A frame check sequence (FCS) is appended, as in step 305, to one or more of the coding blocks, thereby permitting error detection (e.g., CRC) to be performed independently for each block. The coding blocks are then transmitted to a receiver (step 307). Depending on whether transmission errors have been introduced, appropriate acknowledgement signaling (e.g., ACK or NAK) messages are received for the transmission, per step 309. Under this procedure, only those coding blocks that are not acknowledged or associated with a NAK are retransmitted (step 311).

This process is applied to an exemplary burst shown in FIG. 4.

FIG. 4 is a diagram of data frames used in an exemplary error control and data retransmission scheme, according to one embodiment. Under this scenario, a data frame (or burst) 401 is segmented into four coding blocks (e.g., blocks 1-4). A frame check sequence (or CRC field) is added to each of the four coding blocks. Thus, at the receiver, the errors of coding blocks are detected separately. As seen, each coding block has a corresponding ACK/NAK feedback 403. In this example, coding block 1 and coding block 3 were successfully transmitted, while coding block 2 and coding block 4 were not received properly. Consequently, ACK messages are provided for coding block 1 and coding block 3, and NAK messages are used for coding block 2 and coding block 4.

After the transmitter receives NAK feedbacks of some coding blocks in the burst, the transmitter only retransmits these blocks in a new burst 405. The successfully received blocks are not transmitted again. As illustrated, only coding block 2 and coding block 4, along with their respective CRC fields, are included in the retransmission burst 405.

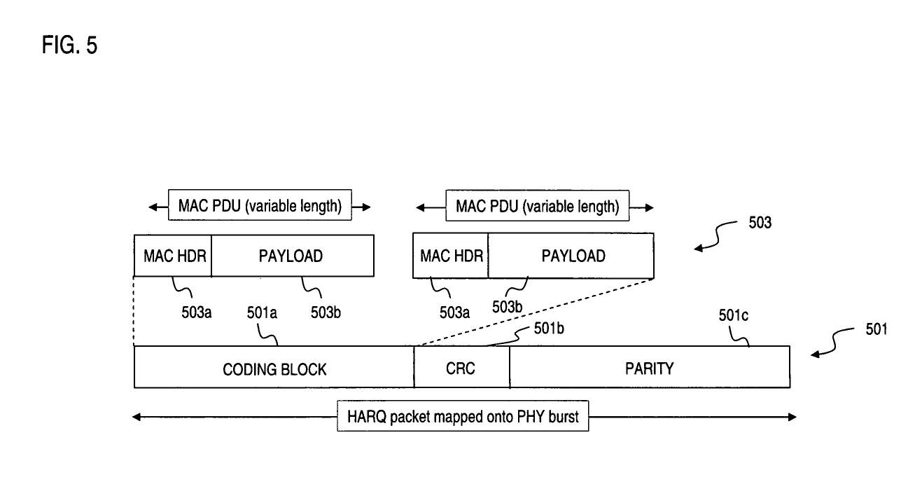

FIG. 5 is an exemplary HARQ encoder packet utilized in the system of FIG. 1. As shown, an HARQ packet is mapped onto a PHY burst 501. The burst 501, in an exemplary embodiment, and includes a coding block 501a, a CRC field 501b, and parity bits 501c. The coding block 501a comprises one or more MAC PDUs 503, each of which includes a MAC header 503a and payload 503b.

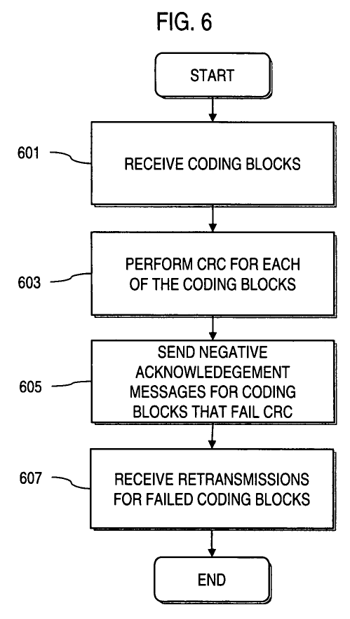

FIG. 6 is a flowchart of a process for acknowledgement signaling in support of an error control mechanism, according to various exemplary embodiments. Continuing with the example of FIG. 4, in step 601, coding blocks 401 are received. The process performs the CRC algorithm to detect transmission errors, per step 603. If errors are found, the process, in an exemplary embodiment, generates NAK messages for the corresponding coding blocks (step 605). In turn, a retransmission burst 405, which contains the required coding blocks, is provided, as in step 607.

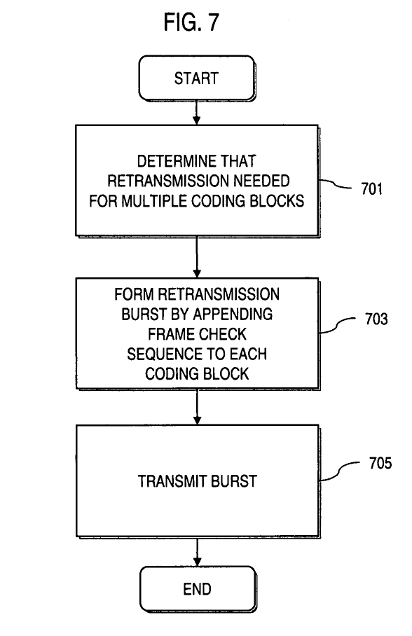

FIG. 7 is a flowchart of a process for providing data retransmission, according to various exemplary embodiments. Under this scenario, it is determined, per step 701, that retransmission is needed for certain coding blocks. Next, the retransmission burst is formed by appending the frame check sequence to each coding block, as in step 703. Thereafter,

the retransmission burst is sent, as in step 707.

The described approach (i.e., HARQ using coding-block-based CRC), according to certain embodiments, provides improvement of the system throughput without introducing more decoding and demodulation complexity. The improvement depends mainly on the following parameters: the coding block size; the target burst error rate of the first transmission; and number of coding blocks in a burst. Moreover, it is contemplated that the coding and modulation scheme could be backward compatible to current IEEE 802.16 specification.

Furthermore, it is contemplated that the above processes can be applied to the uplink (UE to base station) and/or the downlink (base station to UE). It is noted that in an 802.16m network, different CRC overhead results.

The extra overhead introduced include: (1) multiple CRCs are added to a burst, instead of one CRC for a burst in current 802.16 HARQ; and (2) multiple ACK/NAK feedback are used, corresponding to multiple CRCs. In the case of 802.16m, the overhead of feedback for DL and UL HARQ differ. In UL HARQ, the feedback from the base station 103 is one bit for each coding block, which is small bandwidth consumption and could not affect the benefit of the above process. However in DL HARQ, the feedback from MS 101 is half a slot for each coding block, which is a relatively large bandwidth consumption. From this point of view, the processes of FIGS. 3, 6 and 7 may be more suitable for UL HARQ than DL HARQ.

In DL HARQ, two approaches are examined. In “Approach I” the base station 103 sends a “CRC sharing number” to the mobile station 101 through a newly defined field. Subsequently, the MS 101 knows how to perform CRC padding—e.g. if CRC sharing number=2, then there will be a CRC for every two blocks. The base station 103 can elect to change the CRC sharing number of all the controlled MSs 101.

In an alternative embodiment (“Approach II”), the DL HARQ involves appending at most three CRCs. Assuming that the DL burst is fragmented into n coding blocks, and n can be expressed as n=3*u+v, u=1, 2 . . . , v=0, 1, 2, . . . , u-1, then the 1^{st} and 2^{nd} CRC are appended to the 1^{st} and 2^{nd} u coding blocks respectively, and the 3^{rd} CRC is appended to the last u+v coding blocks.

The improvement in throughput for different scenarios is computed as follows. The throughput improvement mainly stems from first retransmissions, due to that the probability of retransmission more than one time is much smaller. First, the following assumptions are made: (1) the target burst error rate of the first transmission is pₑ; (2) the burst is fragmented into n coding blocks; and (3) the maximum coding block size is M bytes.

The target coding block error rate is as follows:

$${p}_{e 1} = 1 - {( 1 - {p}_{e} )}^{\frac{1}{n}} \qquad ( 1 )$$

In this example, n CRCs are appended to the information bits (in contrast to IEEE 802.16, which provides for only 1 CRC to be appended to the information bits). The relative improvement of throughput for the overall throughput (including the 1^{st} transmission and 1^{st} retransmission) is

$$a \approx \frac{n \cdot ( 1 + {p}_{e} )}{n \cdot ( 1 + {p}_{e 1} )} ( \frac{n \cdot M - 2 \cdot n}{n \cdot M - 2} ) - 1 \qquad ( 2 )$$

In (2), n·(1+pₑ) denotes the average bandwidth consumption of the 1^{st} transmission and 1^{st} retransmission using current 802.16 HARQ. n·(1+pₑ₁) denotes the average bandwidth consumption of the 1^{st} transmission and 1^{st} retransmission using our proposal. The factor

$$\frac{n \cdot M - 2 \cdot n}{n \cdot M - 2}$$

addresses the extra overhead introduced by multiple CRCs. (One CRC is two-byte in length.). It is noted that in the computation only the case where all the coding blocks have the same size (i.e. the maximum size) is considered. Additionally, the extra overhead from ACK/NAK feedback is not considered.

For example, MCS of 16 QAM and ½ CTC. M=60. With the assumption of n=4 and pₑ=0.2, the relative improvement in the overall throughput is a≈10.95%.

Using formula (2), the relative throughput improvement of using the proposed HARQ method to different MCS levels when CTC is used can be computed. The results are summarized in Table 1. From the results, it is observed that the improvement increases with the value of M, pₑ and n.

TABLE 1

| | | | | | | | Improvement |
|---|---|---|---|---|---|---|---|
| | M | | Improvement | Improvement | Improvement | Improvement | (%), |
| MCS | (bytes) | pₑ | (%), n = 2 | (%), n = 3 | (%), n = 4 | (%), n = 5 | n = 10 |
| QPSK | 60 | 0.2 | 6.70 | 9.46 | 10.95 | 11.89 | 13.88 |
| (quadrature | | | | | | | |
| phase | | | | | | | |
| shift | | | | | | | |
| keying) | | | | | | | |
| ½ | | | | | | | |
| 16QAM | | | | | | | |
| ½ | | | | | | | |
| 64QAM | | | | | | | |
| ⅚ | | | | | | | |
| QPSK | 54 | 0.2 | 6.49 | 9.17 | 10.63 | 11.55 | 13.48 |
| ¾ | | | | | | | |
| 16QAM | | | | | | | |
| ¾ | | | | | | | |
| 64QAM | | | | | | | |
| ½ | | | | | | | |
| 64QAM | | | | | | | |
| ¾ | | | | | | | |
| 64QAM | 48 | 0.2 | 6.23 | 8.82 | 10.23 | 11.12 | 12.99 |
| ⅔ | | | | | | | |
| QPSK | 60 | 0.1 | 2.86 | 3.94 | 4.51 | 4.86 | 5.58 |
| ½ | | | | | | | |
| 16QAM | | | | | | | |
| ½ | | | | | | | |
| 64QAM | | | | | | | |
| ⅚ | | | | | | | |
| QPSK | 54 | 0.1 | 2.66 | 3.67 | 4.21 | 4.54 | 5.22 |
| ¾ | | | | | | | |
| 16QAM | | | | | | | |
| ¾ | | | | | | | |
| 64QAM | | | | | | | |
| ½ | | | | | | | |
| 64QAM | | | | | | | |
| ¾ | | | | | | | |
| 64QAM | 48 | 0.1 | 2.40 | 3.34 | 3.83 | 4.13 | 4.76 |
| ⅔ | | | | | | | |

According to one embodiment, a one-bit field is defined to identify whether the HARQ using coding-block-based CRC scheme is used. This field could be added to any kind of HARQ-UL-MAP-Subburst-IE. An implementation example is given by modification to UL-HARQ-Chase-Subburst-IE [1] in Table 2. The extension to implementations of other HARQ subburst IE is straightforward. It is noted that in Table 2 the modified fields are shown in bold.

TABLE 2

| Syntax | Size (bit) | Notes |
|---|---|---|
| HARQ Chase UL Sub-Burst IE { | | |
| RCID IE( ) | variable | |
| Dedicated UL Control Indicator | 1 bit | |
| If (Dedicated UL Control Indicator | | |
| ==1) { | | |
| Dedicated UL Control IE ( ) | variable | |
| } | | |
| UIUC | 4 bits | |
| Repetition Coding Indication | 2 bits | |
| Duration | 10 bits | |
| ACID | 4 bits | |
| AI_SN | 1 bit | |
| ACK disable | 1 bits | |
| Multiple_CRC_enable | 1 bit | The flag bit indicating the use of the HARQ |
| | | using coding-block-based CRC approach. All |
| | | the HARQ-enabled MSs could calculate how |
| | | many CRCs are appended to the each bursts, so |
| | | that MS could know which ACK/NAK bits are |
| | | allocated to it. |
| | | 0: enabled |
| | | 1: disabled |
| } | | |

For DL HARQ, another two-bit field could be defined to indicate which kind of CRC appending method is used (e.g., Approach I or Approach II). If Approach I is used, the “CRC sharing number” could be defined as a new TLV, the signaling of this field could have two options: (i) broadcasted through downlink channel descriptor (DCD), so that the whole network has the same value of this parameter; or (ii) included in the HARQ-DL-MAP IE and signaled to MSs per frame.

Another example is given by modification to DL-HARQ-Chase-Subburst-IE [1] in Table 3. The extension to implementations of other HARQ subburst IE is straightforward. In Table 3, the modified fields are provided in bold.

TABLE 3

| Syntax | Size (bit) | Notes |
|---|---|---|
| HARQ Chase DL Sub-Burst IE { | | |
| N sub burst[ISI] | 4 bits | |
| N ACK channel | 6 bits | The number of ACK channels could be larger |
| | | than the number of sub-bursts. |
| For (j = 0; j < N subburst; j++){ | | |
| RCID IE( ) | variable | |
| Duration | 10 bits | |
| CRC appending pattern | 2 bits | The CRC appending pattern: |
| | | 00: 1 CRC per burst, same as current 802.16 |
| | | 01: Approach I |
| | | 10: Approach II |
| | | 11: reserved |
| If (CRC appending | | |
| pattern==01){ | | |
| CRC sharing number | 4 bits | The field defined for Approach I. Only valid |
| | | when Approach I is enabled |
| } | | |
| Sub-Burst DIUC Indicator | 1 bit | |
| RSV | 1 bit | |
| If( Sub-Burst DIUC Indicator == | | |
| 1){ | | |
| DIUC | 4 bits | |
| Repetition Coding Indication | 2 bits | |
| RSV | 2 bits | |
| } | | |
| ACID | 4 bits | |
| AI_SN | 1 bit | |
| ACK disable | 1 bits | |
| Dedicated DL Control Indicator | 2 bit | |
| If( LSB #0 of Dedicated DL Control | | |
| Indicator | | |
| == 1){ | | |
| Duration (d) | 4 bits | |
| If (Duration != 0b0000){ | | |
| Allocation Index | 6 bits | |
| Period (p) | 3 bits | |
| Frame offset | 3 bits | |
| } | | |
| If ( LSB #1 of Dedicated DL Control | | |
| Indicator | | |
| == 1){ | | |
| Dedicated UL Control IE ( ) | variable | |
| } | | |
| } | | |

As mentioned, the described processes may be implemented in any number of radio networks.

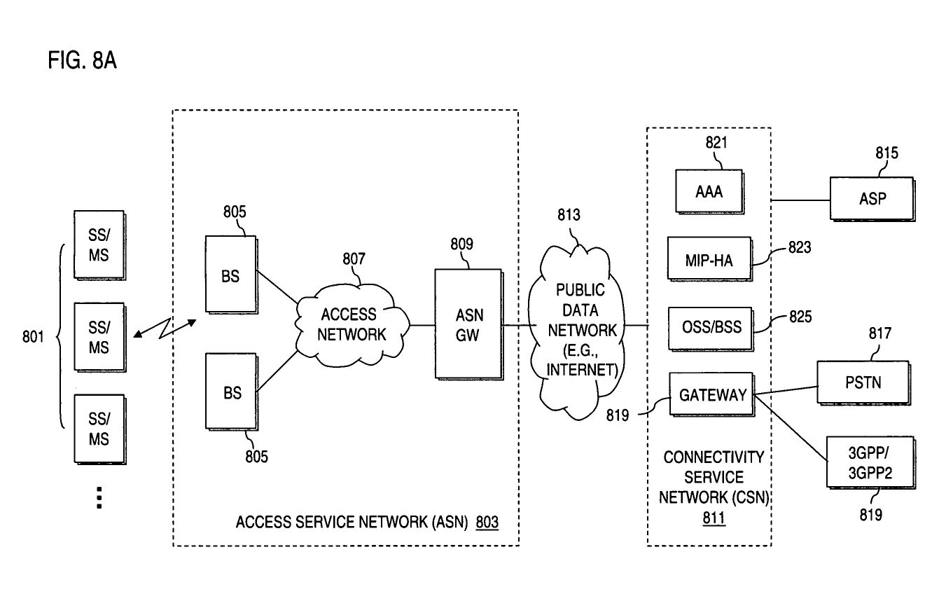

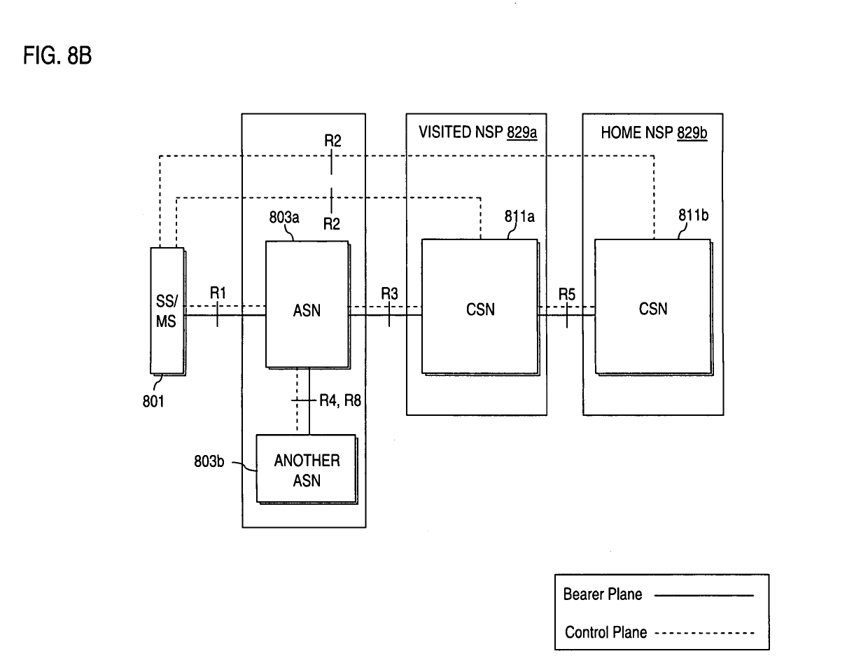

FIGS. 8A and 8B are diagrams of an exemplary WiMAX architecture, in which the system of FIG. 1, according to various exemplary embodiments of the invention. The architecture shown in FIGS. 8A and 8B can support fixed, nomadic, and mobile deployments and be based on an Internet Protocol (IP) service model.

Subscriber or mobile stations 801 can communicate with an access service network (ASN) 803, which includes one or more base stations (BS) 805. In this exemplary system, the BS 805, in addition to providing the air interface to the mobile stations 801, possesses such management functions as handoff triggering and tunnel establishment, radio resource management, quality of service (QoS) policy enforcement, traffic classification, DHCP (Dynamic Host Control Protocol) proxy, key management, session management, and multicast group management.

The base station 805 has connectivity to an access network 807. The access network 807 utilizes an ASN gateway 809 to access a connectivity service network (CSN) 811 over, for example, a data network 813. By way of example, the network 813 can be a public data network, such as the global Internet.

The ASN gateway 809 provides a Layer 2 traffic aggregation point within the ASN 803. The ASN gateway 809 can additionally provide intra-ASN location management and paging, radio resource management and admission control, caching of subscriber profiles and encryption keys, AAA client functionality, establishment and management of mobility tunnel with base stations, QoS and policy enforcement, foreign agent functionality for mobile IP, and routing to the selected CSN 811.

The CSN 811 interfaces with various systems, such as application service provider (ASP) 815, a public switched telephone network (PSTN) 817, and a Third Generation Partnership Project (3GPP)/3GPP2 system 819, and enterprise networks (not shown).

The CSN 811 can include the following components: Access, Authorization and Accounting system (AAA) 821, a mobile IP-Home Agent (MIP-HA) 823, an operation support system (OSS)/business support system (BSS) 825, and a gateway 827. The AAA system 821, which can be implemented as one or more servers, provide support authentication for the devices, users, and specific services. The CSN 811 also provides per user policy management of QoS and security, as well as IP address management, support for roaming between different network service providers (NSPs), location management among ASNs.

FIG. 8B shows a reference architecture that defines interfaces (i.e., reference points) between functional entities capable of supporting various embodiments of the invention. The WiMAX network reference model defines reference points: R1, R2, R3, R4, and R5. R1 is defined between the SS/MS 801 and the ASN 803a; this interface, in addition to the air interface, includes protocols in the management plane. R2 is provided between the SS/MS 801 and a CSN (e.g., CSN 811a and 811b) for authentication, service authorization, IP configuration, and mobility management. The ASN 803a and CSN 811a communicate over R3, which supports policy enforcement and mobility management.

R4 is defined between ASNs 803a and 803b to support inter-ASN mobility. R5 is defined to support roaming across multiple NSPs (e.g., visited NSP 829a and home NSP 829b).

As mentioned, other wireless systems can be utilized, such as 3GPP LTE, as next explained.

FIGS. 9A-9D are diagrams of communication systems having exemplary long-term evolution (LTE) architectures, in which the user equipment (UE) and the base station of FIG. 1 can operate, according to various exemplary embodiments of the invention. By way of example (shown in FIG. 9A), a base station (e.g., destination node) and a user equipment (UE) (e.g., source node) can communicate in system 900 using any access scheme, such as Time Division Multiple Access (TDMA), Code Division Multiple Access (CDMA), Wideband Code Division Multiple Access (WCDMA), Orthogonal Frequency Division Multiple Access (OFDMA) or Single Carrier Frequency Division Multiple Access (FDMA) (SC-FDMA) or a combination of thereof. In an exemplary embodiment, both uplink and downlink can utilize WCDMA. In another exemplary embodiment, uplink utilizes SC-FDMA, while downlink utilizes OFDMA.

The communication system 900 is compliant with 3GPP LTE, entitled “Long Term Evolution of the 3GPP Radio Technology” (which is incorporated herein by reference in its entirety). As shown in FIG. 9A, one or more user equipment (UEs) communicate with a network equipment, such as a base station 103, which is part of an access network (e.g., WiMAX (Worldwide Interoperability for Microwave Access), 3GPP LTE (or E-UTRAN), etc.). Under the 3GPP LTE architecture, base station 103 is denoted as an enhanced Node B (eNB).

MME (Mobile Management Entity)/Serving Gateways 901 are connected to the eNBs 103 in a full or partial mesh configuration using tunneling over a packet transport network (e.g., Internet Protocol (IP) network) 903. Exemplary functions of the MME/Serving GW 901 include distribution of paging messages to the eNBs 103, termination of U-plane packets for paging reasons, and switching of U-plane for support of UE mobility. Since the GWs 901 serve as a gateway to external networks, e.g., the Internet or private networks 903, the GWs 901 include an Access, Authorization and Accounting system (AAA) 905 to securely determine the identity and privileges of a user and to track each user's activities. Namely, the MME Serving Gateway 901 is the key control-node for the LTE access-network and is responsible for idle mode UE tracking and paging procedure including retransmissions. Also, the MME 901 is involved in the bearer activation/deactivation process and is responsible for selecting the SGW (Serving Gateway) for a UE at the initial attach and at time of intra-LTE handover involving Core Network (CN) node relocation.

A more detailed description of the LTE interface is provided in 3GPP TR 25.813, entitled “E-UTRA and E-UTRAN: Radio Interface Protocol Aspects,” which is incorporated herein by reference in its entirety.

In FIG. 9B, a communication system 902 supports GERAN (GSM/EDGE radio access) 904, and UTRAN 906 based access networks, E-UTRAN 912 and non-3GPP (not shown) based access networks, and is more fully described in TR 23.882, which is incorporated herein by reference in its entirety. A key feature of this system is the separation of the network entity that performs control-plane functionality (MME 908) from the network entity that performs bearer-plane functionality (Serving Gateway 910) with a well defined open interface between them S11. Since E-UTRAN 912 provides higher bandwidths to enable new services as well as to improve existing ones, separation of MME 908 from Serving Gateway 910 implies that Serving Gateway 910 can be based on a platform optimized for signaling transactions. This scheme enables selection of more cost-effective platforms for, as well as independent scaling of, each of these two elements. Service providers can also select optimized topological locations of Serving Gateways 910 within the network independent of the locations of MMEs 908 in order to reduce optimized bandwidth latencies and avoid concentrated points of failure.

As seen in FIG. 9B, the E-UTRAN (e.g., eNB) 912 interfaces with UE 101 via LTE-Uu. The E-UTRAN 912 supports LTE air interface and includes functions for radio resource control (RRC) functionality corresponding to the control plane MME 908. The E-UTRAN 912 also performs a variety of functions including radio resource management, admission control, scheduling, enforcement of negotiated uplink (UL) QoS (Quality of Service), cell information broadcast, ciphering/deciphering of user, compression/decompression of downlink and uplink user plane packet headers and Packet Data Convergence Protocol (PDCP).

The MME 908, as a key control node, is responsible for managing mobility UE identifies and security parameters and paging procedure including retransmissions. The MME 908 is involved in the bearer activation/deactivation process and is also responsible for choosing Serving Gateway 910 for the UE 101. MME 908 functions include Non Access Stratum (NAS) signaling and related security. MME 908 checks the authorization of the UE 101 to camp on the service provider's Public Land Mobile Network (PLMN) and enforces UE 101 roaming restrictions. The MME 908 also provides the control plane function for mobility between LTE and 2G/3G access networks with the S3 interface terminating at the MME 908 from the SGSN (Serving GPRS Support Node) 914.

The SGSN 914 is responsible for the delivery of data packets from and to the mobile stations within its geographical service area. Its tasks include packet routing and transfer, mobility management, logical link management, and authentication and charging functions. The S6a interface enables transfer of subscription and authentication data for authenticating/authorizing user access to the evolved system (AAA interface) between MME 908 and HSS (Home Subscriber Server) 916. The S10 interface between MMEs 908 provides MME relocation and MME 908 to MME 908 information transfer. The Serving Gateway 910 is the node that terminates the interface towards the E-UTRAN 912 via S1-U.

The S1-U interface provides a per bearer user plane tunneling between the E-UTRAN 912 and Serving Gateway 910. It contains support for path switching during handover between eNBs 103. The S4 interface provides the user plane with related control and mobility support between SGSN 914 and the 3GPP Anchor function of Serving Gateway 910.

The S12 is an interface between UTRAN 906 and Serving Gateway 910. Packet Data Network (PDN) Gateway 918 provides connectivity to the UE 101 to external packet data networks by being the point of exit and entry of traffic for the UE 101. The PDN Gateway 918 performs policy enforcement, packet filtering for each user, charging support, lawful interception and packet screening. Another role of the PDN Gateway 918 is to act as the anchor for mobility between 3GPP and non-3GPP technologies such as WiMax and 3GPP2 (CDMA 1× and EvDO (Evolution Data Only)).

The S7 interface provides transfer of QoS policy and charging rules from PCRF (Policy and Charging Role Function) 920 to Policy and Charging Enforcement Function (PCEF) in the PDN Gateway 918. The SGi interface is the interface between the PDN Gateway and the operator's IP services including packet data network 922. Packet data network 922 may be an operator external public or private packet data network or an intra operator packet data network, e.g., for provision of IMS (IP Multimedia Subsystem) services. Rx+ is the interface between the PCRF and the packet data network 922.

As seen in FIG. 9C, the eNB 103 utilizes an E-UTRA (Evolved Universal Terrestrial Radio Access) (user plane, e.g., RLC (Radio Link Control) 915, MAC (Media Access Control) 917, and PHY (Physical) 919, as well as a control plane (e.g., RRC 921)). The eNB 103 also includes the following functions: Inter Cell RRM (Radio Resource Management) 923, Connection Mobility Control 925, RB (Radio Bearer) Control 927, Radio Admission Control 929, eNB Measurement Configuration and Provision 931, and Dynamic Resource Allocation (Scheduler) 933.

The eNB 103 communicates with the aGW 901 (Access Gateway) via an S1 interface. The aGW 901 includes a User Plane 901a and a Control plane 901b. The control plane 901b provides the following components: SAE (System Architecture Evolution) Bearer Control 935 and MM (Mobile Management) Entity 937. The user plane 901b includes a PDCP (Packet Data Convergence Protocol) 939 and a user plane functions 941. It is noted that the functionality of the aGW 901 can also be provided by a combination of a serving gateway (SGW) and a packet data network (PDN) GW. The aGW 901 can also interface with a packet network, such as the Internet 943.

In an alternative embodiment, as shown in FIG. 9D, the PDCP (Packet Data Convergence Protocol) functionality can reside in the eNB 103 rather than the GW 901. Other than this PDCP capability, the eNB functions of FIG. 9C are also provided in this architecture.

In the system of FIG. 9D, a functional split between E-UTRAN and EPC (Evolved Packet Core) is provided. In this example, radio protocol architecture of E-UTRAN is provided for the user plane and the control plane. A more detailed description of the architecture is provided in 3GPP TS 86.300.

The eNB 103 interfaces via the S1 to the Serving Gateway 945, which includes a Mobility Anchoring function 947. According to this architecture, the MME (Mobility Management Entity) 949 provides SAE (System Architecture Evolution) Bearer Control 951, Idle State Mobility Handling 953, and NAS (Non-Access Stratum) Security 955.

One of ordinary skill in the art would recognize that the processes for acknowledgement signaling may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

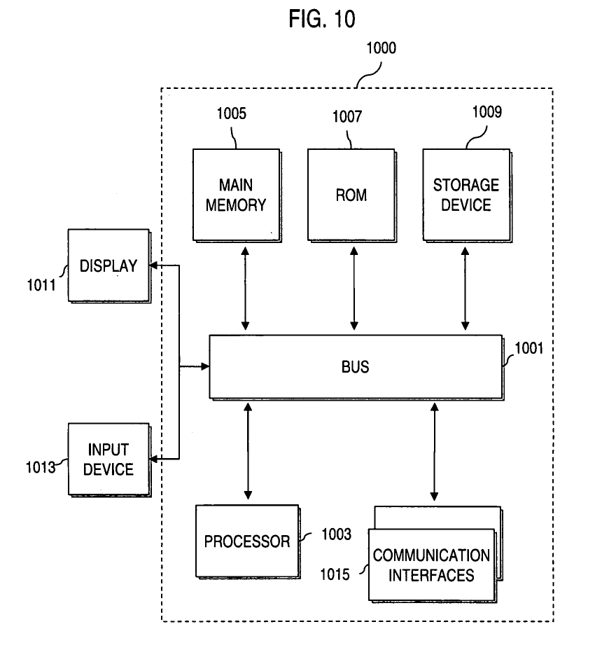

FIG. 10 illustrates exemplary hardware upon which various embodiments of the invention can be implemented. A computing system 1000 includes a bus 1001 or other communication mechanism for communicating information and a processor 1003 coupled to the bus 1001 for processing information. The computing system 1000 also includes main memory 1005, such as a random access memory (RAM) or other dynamic storage device, coupled to the bus 1001 for storing information and instructions to be executed by the processor 1003. Main memory 1005 can also be used for storing temporary variables or other intermediate information during execution of instructions by the processor 1003. The computing system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computing system 1000 may be coupled via the bus 1001 to a display 1011, such as a liquid crystal display, or active matrix display, for displaying information to a user. An input device 1013, such as a keyboard including alphanumeric and other keys, may be coupled to the bus 1001 for communicating information and command selections to the processor 1003. The input device 1013 can include a cursor control, such as a mouse, a trackball, or cursor direction keys, for communicating direction information and command selections to the processor 1003 and for controlling cursor movement on the display 1011.

According to various embodiments of the invention, the processes described herein can be provided by the computing system 1000 in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 1000 also includes at least one communication interface 1015 coupled to bus 1001. The communication interface 1015 provides a two-way data communication coupling to a network link (not shown). The communication interface 1015 sends and receives electrical, electromagnetic, or optical signals that carry digital data streams representing various types of information. Further, the communication interface 1015 can include peripheral interface devices, such as a Universal Serial Bus (USB) interface, a PCMCIA (Personal Computer Memory Card International Association) interface, etc.

The processor 1003 may execute the transmitted code while being received and/or store the code in the storage device 1009, or other non-volatile storage for later execution. In this manner, the computing system 1000 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

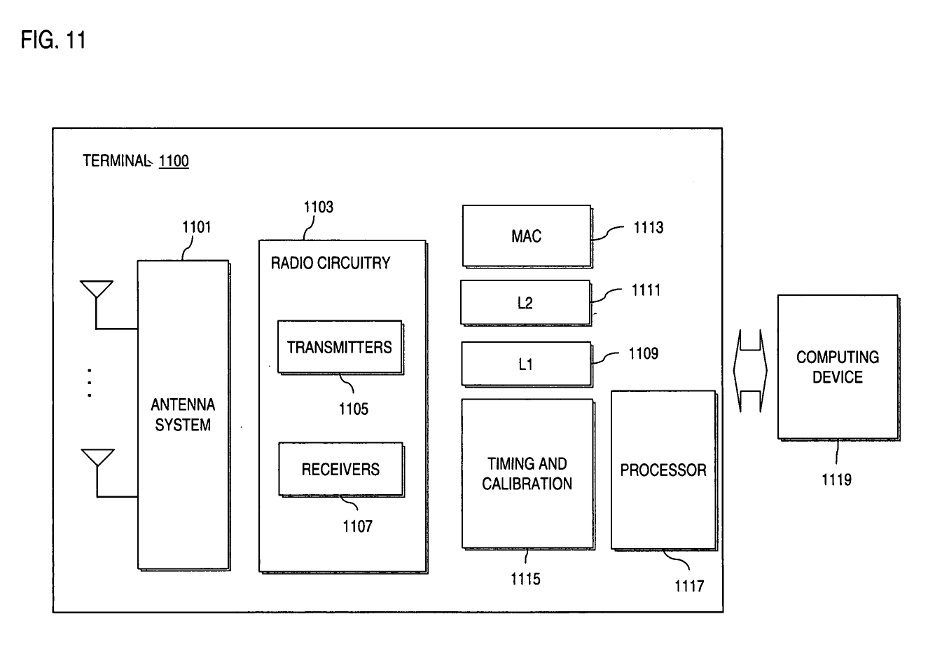

FIG. 11 is a diagram of exemplary components of a user terminal configured to operate in the systems of FIGS. 8 and 9, according to an embodiment of the invention. A user terminal 1100 includes an antenna system 1101 (which can utilize multiple antennas) to receive and transmit signals. The antenna system 1101 is coupled to radio circuitry 1103, which includes multiple transmitters 1105 and receivers 1107. The radio circuitry encompasses all of the Radio Frequency (RF) circuitry as well as base-band processing circuitry. As shown, layer-1 (L1) and layer-2 (L2) processing are provided by units 1109 and 1111, respectively. Optionally, layer-3 functions can be provided (not shown). Module 1113 executes all Medium Access Control (MAC) layer functions. A timing and calibration module 1115 maintains proper timing by interfacing, for example, an external timing reference (not shown). Additionally, a processor 1117 is included. Under this scenario, the user terminal 1100 communicates with a computing device 1119, which can be a personal computer, work station, a Personal Digital Assistant (PDA), web appliance, cellular phone, etc.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining that an error control mechanism is enabled for transmission of a data frame;
fragmenting the data frame into a plurality of coding blocks; and
appending a frame check sequence to one or more sequences of the coding blocks, wherein each of the sequences associated with the frame check sequence is to be acknowledged separately.

2. A method according to claim 1, further comprising:
selectively receiving an acknowledgement message for each of the sequences associated with the frame check sequence; and
retransmitting only coding blocks that are not acknowledged.

3. A method according to claim 1, wherein the error control mechanism includes a hybrid Automatic Repeat Request scheme, and the frame check sequence corresponds to a cyclic redundancy check scheme.

4. A method according to claim 1, further comprising:
transmitting a cyclic redundancy check sharing number over a downlink to a mobile station configured to receive the data frame for sharing a cyclic redundancy check among two or more of the coding blocks.

5. A method according to claim 1, wherein the frame check sequence is appended to all the coding blocks.

6. A method according to claim 1, wherein the data frame is a physical layer transmission burst.

7. A method according to claim 1, wherein the fragmentation is performed according to an Institute of Electrical & Electronics Engineers 802.16 protocol suite.

8. A method according to claim 1, wherein the coding blocks are transmitted over a radio communication network compliant with a Worldwide Interoperability for Microwave Access architecture.

9. A computer-readable storage medium carrying one or more sequences of one or more instructions which, when executed by one or more processors, cause the one or more processors to perform the method of claim 1.

10. An apparatus comprising:
logic configured to determine that an error control mechanism is enabled for transmission of a data frame; and
a fragmentation module configured to fragment the data frame into a plurality of coding blocks,
wherein the logic is further configured to append a frame check sequence to one or more sequences of the coding blocks, each of the sequences associated with the frame check sequence being acknowledged separately.

11. An apparatus according to claim 10, wherein the error control mechanism is configured to selectively receive an acknowledgement message for each of the sequences associated with the frame check sequence, only coding blocks that are not acknowledged are retransmitted.

12. An apparatus according to claim 10, wherein the error control mechanism includes a hybrid Automatic Repeat Request scheme, and the frame check sequence corresponds to a cyclic redundancy check scheme.

13. An apparatus according to claim 10, further comprising:
a transceiver configured to transmit a cyclic redundancy check sharing number over a downlink to a mobile station configured to receive the data frame for sharing a cyclic redundancy check among two or more of the coding blocks.

14. An apparatus according to claim 10, wherein the frame check sequence is appended to all the coding blocks.

15. An apparatus according to claim 10, wherein the data frame is a physical layer transmission burst.

16. An apparatus according to claim 10, wherein the fragmentation is performed according to an Institute of Electrical & Electronics Engineers 802.16 protocol suite.

17. An apparatus according to claim 10, wherein the coding blocks are transmitted over a radio communication network compliant with a Worldwide Interoperability for Microwave Access architecture.

18. A method comprising:
receiving a plurality of coding blocks representing a fragmented data frame;
computing a frame check sequence associated with one or more sequences of the coding blocks; and
generating an acknowledgement signal, according to an error detection scheme, for each of the sequences associated with the frame check sequence.

19. A computer-readable storage medium carrying one or more sequences of one or more instructions which, when executed by one or more processors, cause the one or more processors to perform the method of claim 18.

20. An apparatus comprising:
a processor configured to receive a plurality of coding blocks representing a fragmented data frame, and to compute a frame check sequence associated with one or more sequences of the coding blocks,
wherein the processor is further configured to generate an acknowledgement signal, according to an error detection scheme, for each of the sequences associated with the frame check sequence.

21. An apparatus according to claim 20, wherein the apparatus is a mobile station.
